(19) United States
(12) Patent Application Publication
(10) Pub. No.: US 2016/0039658 A1
(43) Pub. Date: Feb. 11, 2016

(54) FLUID VENDING TECHNOLOGY

(71) Applicant: Chris Willeke, Hudson, WI (US)

(72) Inventor: Chris Willeke, Hudson, WI (US)

(21) Appl. No.: 14/682,736

(22) Filed: Apr. 9, 2015

Related U.S. Application Data
(60) Provisional application No. 61/977,460, filed on Apr. 9, 2014.

(51) Int. Cl. B67D 7/30; B67D 7/16; B67D 7/42; G01F 23/30; B67D 7/02

(52) U.S. Cl. CPC B67D 7/305; G01F 23/30; B67D 7/02; B67D 7/42; B67D 7/16

(57) ABSTRACT

A bulk windshield washer fluid vending system. The system includes a storage tank for storing fluid, a controller communicatively connected to the fluid storage tank for managing flow of fluid from the fluid storage tank, a fluid flow line connected to the controller, and a vending mechanism connected to the fluid flow line and disposed at it predetermined location remote from the fluid storage tank for actuation by a customer

### CROSS REFERENCE TO RELATED APPLICATIONS, IF ANY

This application claims the benefit under 35 U.S.C. §119(e) of co-pending U.S. Provisional Patent Application Serial No.61/977,460, filed Apr. 9, 2014, which is hereby incorporated by reference.

### 37 C.F.R. §1.71(E) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to vending systems, apparatus and methods. Particularly, the invention relates to a bulk fluid vending system. The invention most particularly relates to a bulk windshield washer fluid vending system. The invention is usefull at, for example, gas and service stations, rest areas, auto dealers, auto centers, and rental car centers.

2. Background Information

Existing technology in this field of supplying windshield washer fluid and other fluids at gas and service stations, rest areas, auto dealers, auto centers, and rental car centers is believed to have significant limitations and shortcomings.

Known systems in the art include U.S. Pat. No. 6,239,939 to Willeke et al, entitled Windshield Washer Fluid Dispensing System, U.S. Pat. No. 6,311,873 to Willeke et al., entitled Automotive Fluid Dispensing System, and U.S. Pat. No. 6,585,011 to Willeke, Jr. et al. entitled Squeegee Bucket Fluid Fill Device and System.

All U.S. patents and patent applications, and all other published documents mentioned anywhere in this application are incorporated by reference in their entirety.

### BRIEF SUMMARY OF THE INVENTION

The present invention provides a bulk windshield washer fluid vending apparatus and methods which are practical, reliable, accurate and efficient, and which are believed to constitute an improvement over the background technology.

The apparatus and methods of the invention provide an economical, sustainable and environmentally friendly means of dispensing windshield washer fluids to end users. The invention permits system owners increase profits and better satisfy end user customers. The system minimizes ordering and shipping costs versus common supply by way of plastic jugs (typically approx. 1 gallon containers) shipped and provided in boxes of four (4) or more, and plastic lined boxes. Retail team workers spend less time handling merchandise and can thus focus on customers specific needs. Equipment costs are minimized. Inventory, and therefore cost, is minimized, and so is inventory processing. Product shrinkage is minimized. Paperwork is minimized. And finally, plastic and cardboard trash and waste is minimized both at the system owner's premises and in local landfills. End user customer's windshield washing experience is improved by always having a full, clean squeegee bucket.

In one aspect, the invention provides an apparatus for dispensing bulk fluids, comprising at least one fluid storage tank for storing fluid, a controller communicatively connected to the at least one fluid storage tank for managing flow of fluid from the fluid storage tank, at least one fluid flow line connected to the controller, and a vending mechanism connected to the fluid flow line and disposed at a predetermined location remote from the fluid storage tank and adapted to be actuated by a customer.

In another aspect, the invention provides An apparatus for bulk windshield washer fluid vending at a service station, comprising:

(a) at least one fluid storage tank for storing windshield washing fluid,

(b) a controller communicatively connected to the at least one fluid storage tank for managing flow of fluid from the fluid storage tank,

(c) at least one fluid flow line connected to the controller, and

(d) a vending mechanism connected to the fluid flow line and disposed at a predetermined location remote from the fluid storage tank and adapted to be actuated by a customer, wherein the vending mechanism comprises a hand holdable fluid vending nozzle adapted to be used on a customer to dispense fluid to a remote container, and a customer access unit for controlling flow of fluid to the vending nozzle, the customer access unit being selected from the group of devices consisting of a card reader and a cash payment mechanism.

And in another aspect, the invention provides a method of dispensing fluids, comprising the steps of (a) providing an apparatus for bulk fluid vending, comprising at least one fluid storage tank for storing fluid, a controller communicatively connected to the at least one fluid storage tank for managing flow of fluid from the fluid storage tank, at least one fluid flow line connected to the controller, and a vending mechanism connected to the fluid flow line and disposed at a predetermined location remote from the fluid storage tank and adapted to be actuated by a customer; (b) detecting a dispense signal at the vending mechanism, and (c) delivering fluid from the fluid storage tank to the vending mechanism

The present invention is believed to involve novel elements, combined in novel ways to yield more than predictable results. The problems solved by the invention were not fully recognized in the prior art.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a diagram of components and their arrangement of an embodiment of the bulk windshield washer fluid vending system of the present invention.

FIG. 2 is a diagram of an embodiment of the plumbing of the system of the invention.

FIG. 3 is a diagram of an embodiment of the electrical wiring of the system of the invention.

FIG. 4 is circuit schematic of an embodiment of the dispenser of the system.

FIG. 5 is an overview diagram of an embodiment of the control box of the system.

FIG. 6 is a diagram of the electrical connections of an embodiment of the control box.

FIG. 7 is a further diagram of the electrical connections of FIG. 6.

FIG. 8A is a view of an embodiment of the vending unit of the system of the invention.

FIG. 8B is a view of an embodiment of the vending unit of the system of the invention.

FIG. 8C is a view of an embodiment of the vending unit of the system of the invention.

FIG. 9A is a view of the frame of the vending unit.

FIG. 9B is a view of the frame of the vending unit.

FIG. 10A is a further view of the frame of the vending unit.

FIG. 10B is a further view of the frame of the vending.

FIG. 11 is a flow diagram showing an embodiment of the bulk fluid vending process of the invention.

FIG. 12A is a view of an embodiment of the tank of the system.

FIG. 12B is a view of an embodiment of the tank of the system.

FIG. 12C is a view of an embodiment of the tank of the system.

FIG. 13 shows an embodiment of a sensor of the system.

FIG. 14 shows an embodiment of the vending unit of the system.

FIG. 15A is a further view of an embodiment of the tank of the system of the invention.

FIG. 15B is a further view of n embodiment of the tank of the system of the invention.

FIG. 15C is a further view of an embodiment of the tank of the system of the invention.

FIG. 16A is a view of an embodiment of a tank foot.

FIG. 16B is a view of an embodiment of a tank foot.

FIG. 16C is a view of an embodiment of a tank foot.

FIG. 17 is an end view of an embodiment of the tank installation.

### DETAILED DESCRIPTION

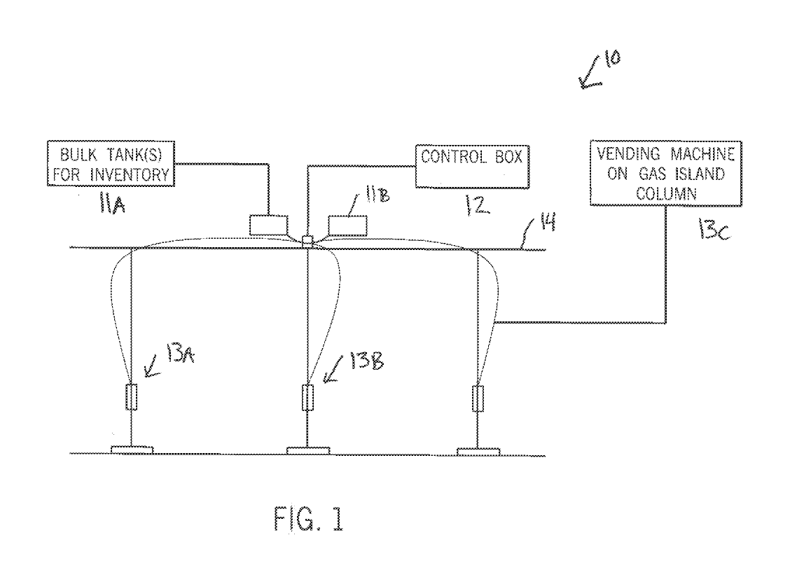

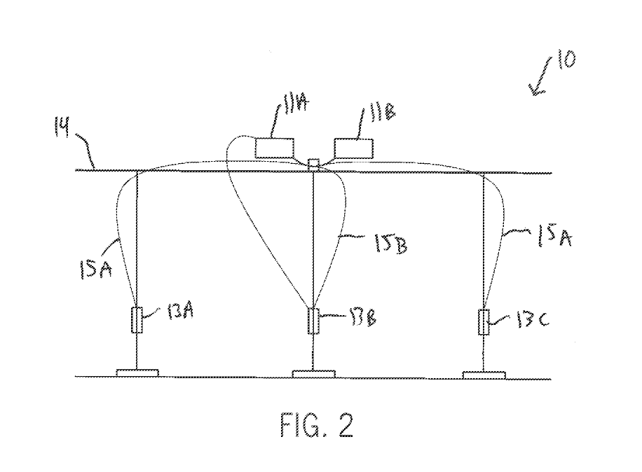

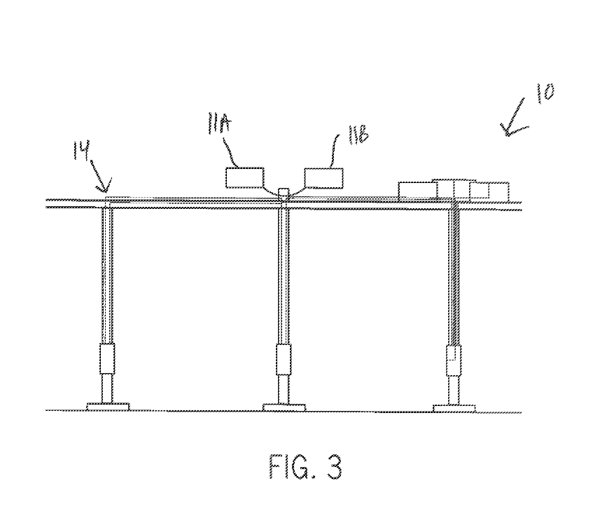

Referring to FIGS. 1-3, an embodiment of the bulk windshield washer fluid vending system 10 and its primary components, interconnection and arrangement are shown and described. FIG. 1 is a diagram of components of the bulk windshield washer fluid vending system 10 comprising at least one bulk tank 11, a control box 12 and at least one vending unit 13. In the example embodiment, a pair of bulk tanks 11, preferably 100-gallon tanks, are mounted on 1⅝ slotted Unistrut (P1000T) using notch type beam clamp (Fastnal part 48840) mounted on the I-beam superstructure 14 of a facility such as a service station or the like. The tanks 11 are preferably secured with steel strapping. The control box 12 is preferably enclosed with 12″×18″ NEMA plastic enclosure. The vending units 13 are installed according to ADA. FIG. 2 is a diagram of the plumbing of the system. Fill-lines 15 are preferably polyethylene black tubing which convey product up through central column to the control manifold 12 on roof 14. ¾″ tubing is provided from manifold to top of each tank. Bulkheads and fittings are provided at lower end of each tank 11 and ⅜″ black PE tubing is provided between tanks to create shared inventory. Bulkhead and fitting are provided in one tank, and ½ tubing from tank 11 to control box 12. The control box 12 receives product and supplies on demand to vending machines 13. 5. Each vending machine 13 dispenses via ¼″ recoiling hose fitted with hand-held-actuated nozzle. A check valve is provided with adequate spring pressure between hose and nozzle to prevent draining hose and transaction to complete. FIG. 3 is a diagram of the electrical wiring of the system. 115V AC power is provided to the control box 12 on roof structure 14. 2. 24V power is provided to all vending units 13. A communications cable is provided to all vending units 13 from control box 12. Level float switches are provided in tank 11 with connection to the control box 12 PLC. A minimum level switch must put the system out of service. A maximum level switch indicates that the system is full. 5. A light indicator is preferably provided at supply fill-line connection point to indicate when the system 10 is full. Additionally, Red-Level is sensor. Purple—⅜″ is Vending supply line. Blue—¼″ is bucket insert supply line. Green—¾″ is Fill line. Yellow—¾″ is union line.

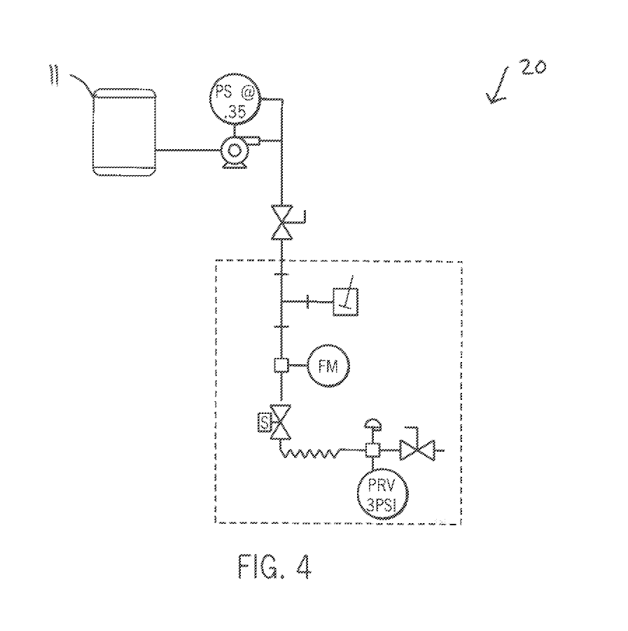

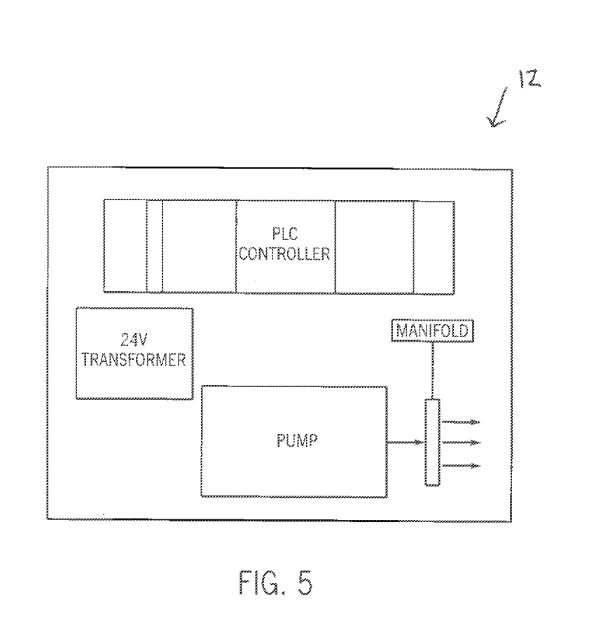

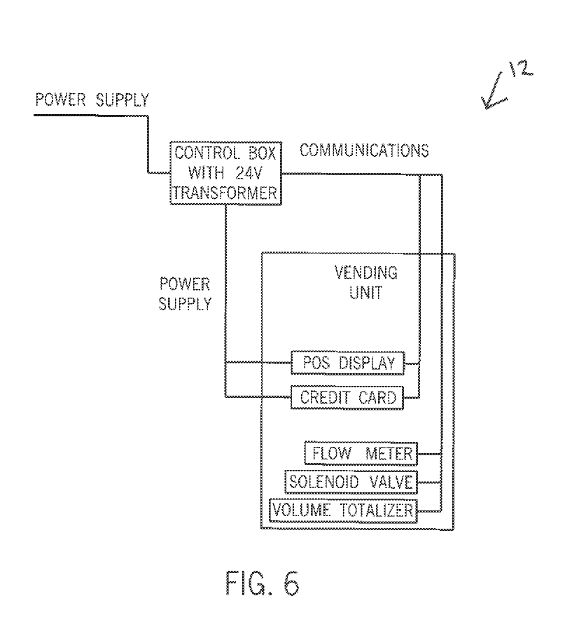

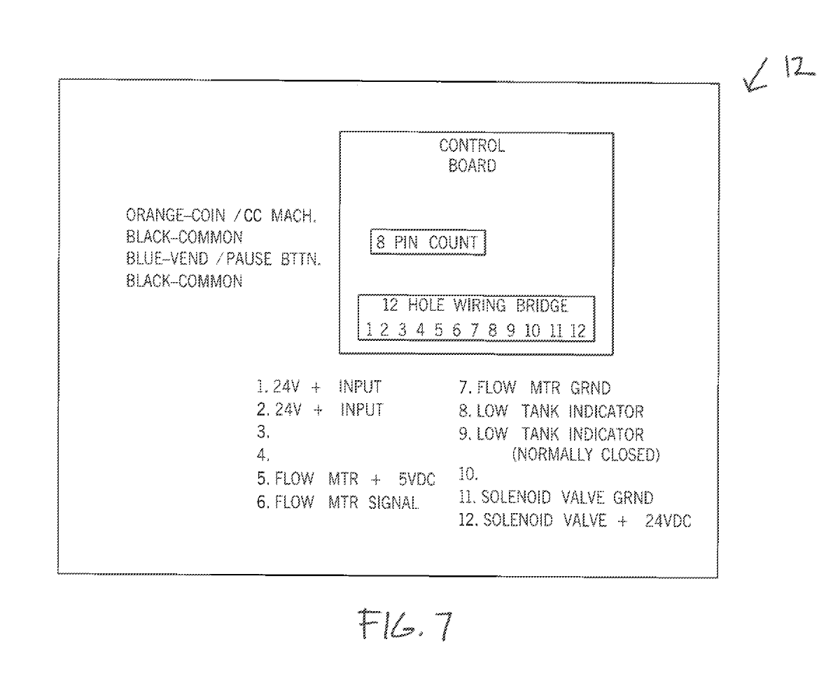

FIGS. 4-7 show and describe an embodiment of the electrical components, interconnection and expected behavior of the bulk windshield washer fluid vending system 10. FIG. 4 is circuit schematic 20 of the system 10. FIG. 5 is an overview diagram of the control box 12 of the system 10. FIG. 6 is a diagram of the electrical connections of an embodiment of the control box 12. In the preferred wiring diagram: 115 V AC power is provided to the control box 12 on roof structure 14. 24V power to all vending units 13. Communications cable is provided to all vending units 13 from control box 12. A separate cable is provided from calibration boxes at each vending machine 13 to PLC unit 12. Equipment Specifications preferably include: (1) Program Logic Controller (PLC). (2) ShurFlow 8025, 1.4 GPS, 60 PSI, 115 VAC. (3) Gems Sensors F110 Flow meter (see attachment 2). (4) Vending unit with point of sale device on exterior and sealable box containing calibration dials. FIG. 7 is a further diagram of the electrical connections of FIG. 6. A preferred typical wiring diagram for control board includes: (1) providing 115 V AC to control box 12, (2) providing 24V to the vending units 13, providing communications cable to the vending units 13 from the control box 12, and (4) providing separate cable from the calibration boxes at the vending machine 13 to the PLC unit. Equipment specifications are preferably: (1) a Program Logic Controller (PLC), a SureFlow 8025 (1.4 GPM, 60 PSI, 115V AC), (3) Gems Sensors F110 Flow meter, and (4) Vending units with point of sale device on exterior and a scalable box containing calibration dials. The equipment functions as follows: (1) the PLC initiates a dispensing process when a qualified transaction has occurred through a point of sale device, (2) the PLC opens the solenoid valve at a corresponding vending machine where the qualified transaction was initiated, and monitors the flow meter, (3) the pump on-demand switch activates and pump transfers product through the flow meter and solenoid valve at the vending machine, and (4) the PLC closes the solenoid valve when calibrated set point is achieved. The control board is wired by (1) 110/120V AC power to transformer (preferably a Heath/Zenith DW-125 24 VAC transformer), (2) 24V power to transformer, and (3) the transformer is connected to power supply at a wiring bridge.

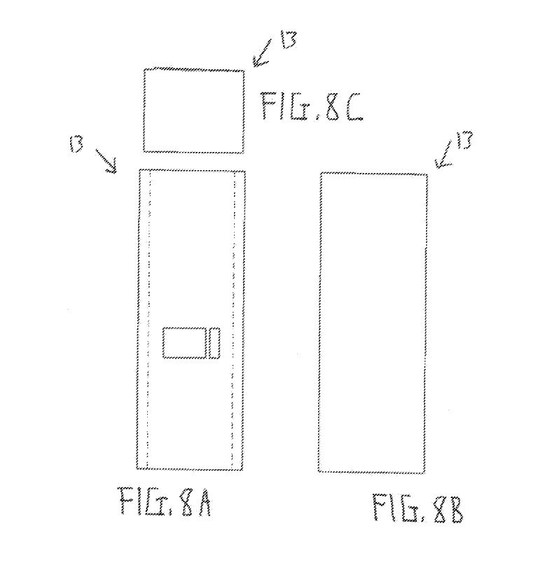

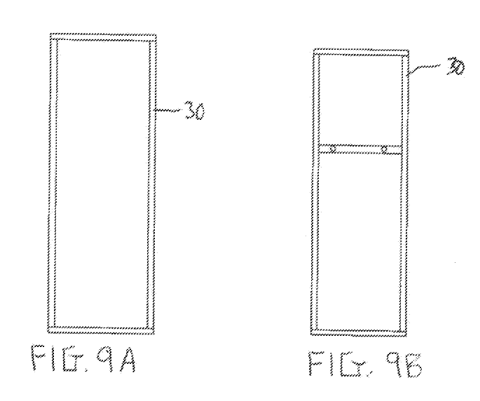

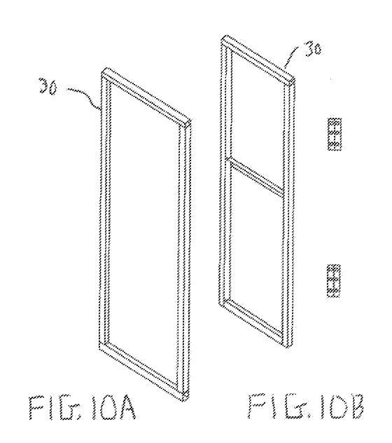

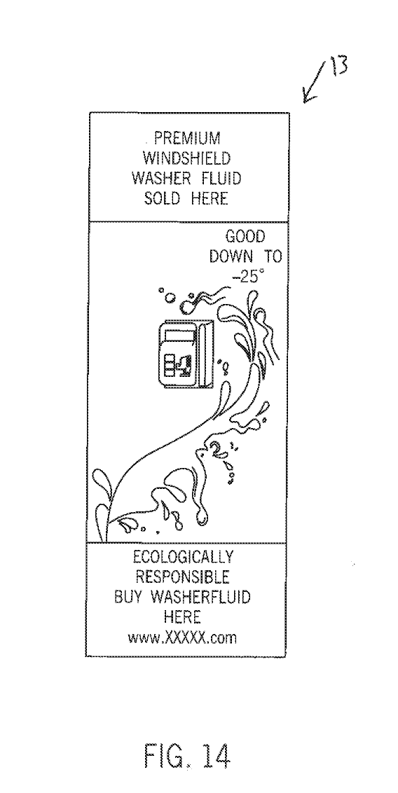

FIGS. 8, 9, 10 and 14 show and describe an embodiment of the vending unit 13 of the system. FIGS. 8A-C are views of the vending unit. Typical Design: 1. Provide credit card swipe and interactive screen centered 12″ from bottom of unit. 2. Provide a NEMA sealable box to house calibration dials, permanently installed inside vending unit. 3. Unit constructed of Aluminum composite paneling 3/32″ black plastic with graphics that explain how to operate unit. 4. Provide recoil hose with spring pressure check valve between hose and nozzle. 5. Provide hand-operated nozzle valve at end of hose/check valve. 6. Provide hanger on front of vending unit for hose/nozzle. 7. Provide graphics to assist in transaction and use of equipment (see Attachment 3). FIGS. 9A and B are views of the frame 30 of the vending unit 13. Typical framing: 1. Frame constructed of ¾″ angle steel frame. 2. Butt ends. 3. Internal frame pivots on rear frame with 5/16″ bolts. 4. Provide drawer lock on side of top frame. 5. Provide mounting bracket on rear panel with ⅜″ pilot holes. FIGS. 10A and B are further views of the frame 30. Typical framing: 1. Provide drawer T-handle lock side action for interior frame to lock into rear framework. 2. Provide mounting bracket on rear panel with ¼″ pilot holes. 3. Provide hinges for door to mount on internal frame. FIG. 14 shows an embodiment of the vending unit 13 of the system.

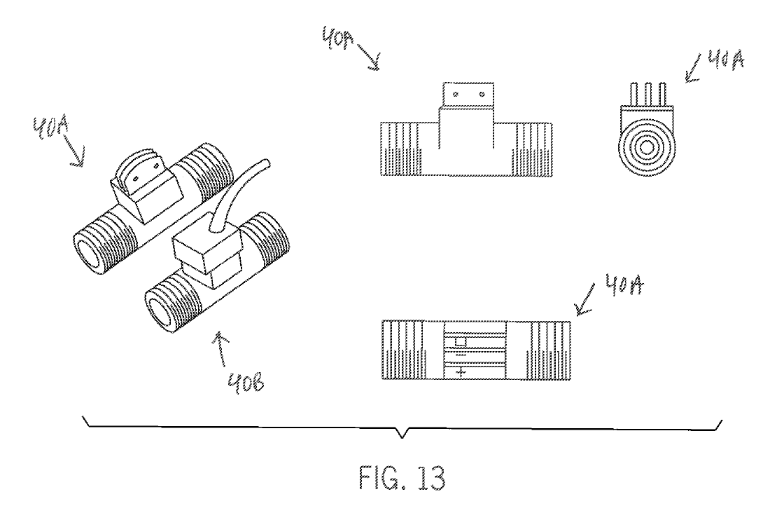

FIG. 13 shows and describes an embodiment of a sensor 40A or 40B of the system 10.

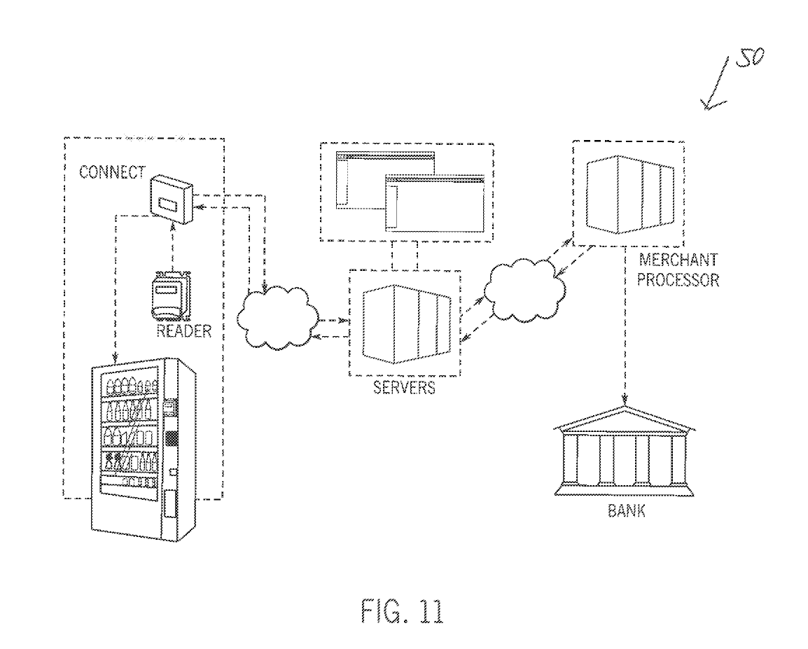

FIG. 11 is a flow diagram showing and describing an embodiment of the bulk fluid vending process 50 of the invention. A card is read by a reader. Data is sent to a Connection server. Data is transmitted to the servers. A card transaction request is sent to a merchant processor. If approved, data is sent back to the machine authorizing the purchase. The purchase is executed and data fed to the servers. The transaction is processed and funds deposited to a bank.

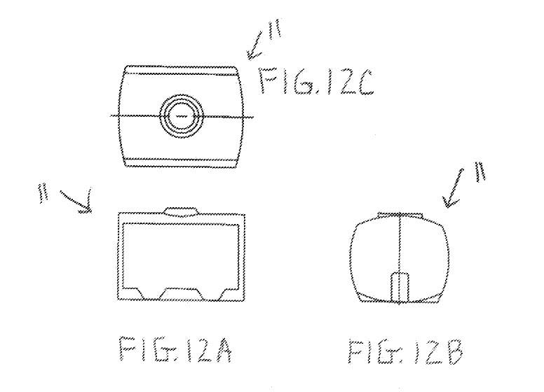

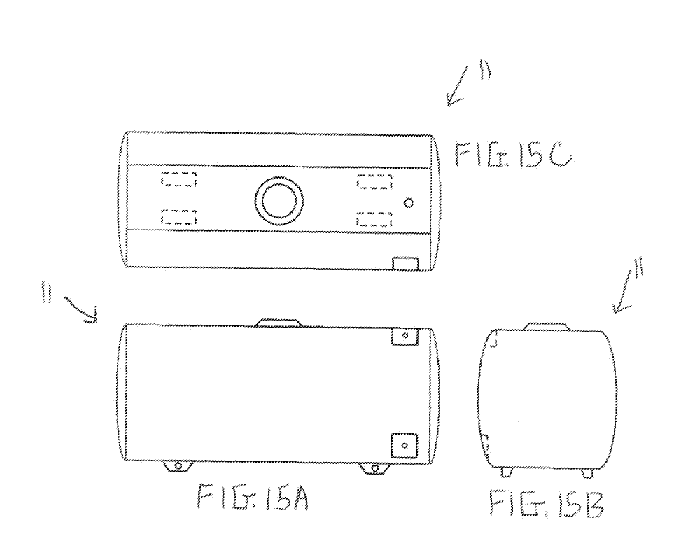

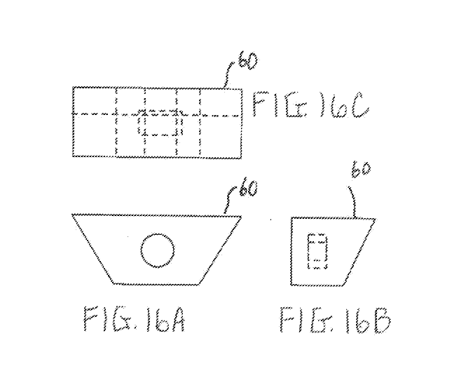

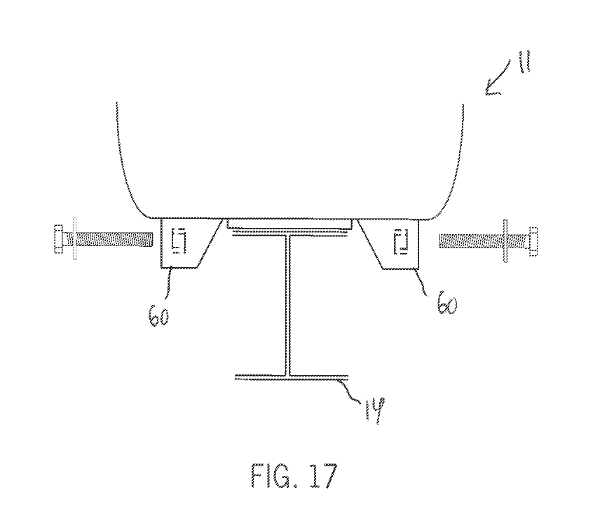

FIGS. 12, 15, 16 and 17 show and describe an embodiment of the tank 11 of the system. FIGS. 12A-C are views of the tank 11. FIGS. 15A-C are further views of the tank 11. Equipment design schedule: 1. Tank capacity is approximately 100-gallon. 2. Provide 5″ access cap on top of tank not to exceed depth of feet. 3. Provide ½″ embedded nuts in feet of tank. 4. Provide ¾″ FPT fitting centered in lower corner recess for outflow and ⅜″ FPT in upper recess for bleed line. 5. Provide ¾″ FPT fitting for inflow. FIGS. 16A-C are views of a tank foot 60. Equipment design schedule: 1. Embed in center of foot ½″ zinc coated nut for mounting procedure. And, FIG. 17 is an end view of an embodiment of the tank 11 installation. Tank Installation schedule: 1. Place ¼″ spacer (as needed) on I-Beam 14 and center tank over I-Beam on the spacer board. 2. Using ½″ washer, tighten ½″×6″ bolts through feet to I-Beam vertical edge.

A preferred embodiment of the apparatus for dispensing bulk fluids comprises at least one fluid storage tank for storing fluid, a controller communicatively connected to the at least one fluid storage tank for managing flow of fluid from the fluid storage tank, at least one fluid flow line connected to the controller, and a vending mechanism connected to the fluid flow line and disposed at a predetermined location remote from the fluid storage tank and adapted to be actuated by a customer. The bulk fluid is preferably windshield washer fluid. In an exemplary embodiment, the fluid storage tank has a capacity of approximately 100 gallons. The controller monitors the supply of fluid in the fluid storage tank and in the vending mechanism. The controller may monitor supply via a float mechanism disposed in the fluid storage tank or the vending mechanism. The controller permits a predetermined flow of fluid from the fluid storage tank to the fluid flow line upon sensing a low fluid condition in the vending mechanism. The controller may include a flow rate sensor. It may include a pump. Alternatively, flow may be managed primarily or all via gravity flow. The fluid flow line is preferably constructed of polyethylene tubing. The vending mechanism may comprise a fluid bucket for holding a predetermined volume of fluid and has an access aperture adapted to hold and supply fluid to a squeegee tool. It may further have a paper towel dispenser. Alternatively, the vending mechanism may comprise a hand holdable fluid vending nozzle adapted to be used on a customer to dispense fluid to a remote container. the vending mechanism further comprises a customer access unit for controlling flow of fluid to the vending nozzle. The vending mechanism may further comprise a customer access unit for controlling flow of fluid to the vending nozzle, such as a card reader and/or a cash payment mechanism.

An embodiment of the method of the invention includes the steps of (a) providing an apparatus for bulk fluid vending, comprising at least one fluid storage tank for storing fluid, a controller communicatively connected to the at least one fluid storage tank for managing flow of fluid from the fluid storage tank, at least one fluid flow line connected to the controller, and a vending mechanism connected to the fluid flow line and disposed at a predetermined location remote from the fluid storage tank and adapted to be actuated by a customer; (b) detecting a dispense signal at the vending mechanism, and (c) delivering fluid from the fluid storage tank to the vending mechanism

The apparatus and methods of the invention provide an economical, sustainable and environmentally friendly means of dispensing windshield washer fluids to end users. The invention permits system owners increase profits and better satisfy end user customers. The system minimizes ordering and shipping costs versus common supply by way of plastic jugs (typically approx. 1 gallon containers) shipped and provided in boxes of four (4) or more, a d plastic lined boxes. Retail team workers spend less time handling merchandise and can thus focus on customers specific needs. Equipment costs are minimized. Inventory, and therefore cost, is minimized, and so is inventory processing. Product shrinkage is minimized. Paperwork is minimized. And finally, plastic and cardboard trash and waste is minimized both at the system owner's premises and in local landfills. End user customer's windshield washing experience is improved by always having a full, clean squeegee bucket.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. An apparatus for dispensing bulk fluids, comprising at least one fluid storage tank storing fluid, a controller communicatively connected to the at least one fluid storage tank for managing flow of fluid from the fluid storage tank, at least one fluid flow line connected to the controller, and a vending mechanism connected to the fluid flow line and disposed at a predetermined location remote from the fluid storage tank and adapted to be actuated by a customer.

2. The apparatus of claim 1, wherein the bulk fluid is windshield washer fluid.

3. The apparatus of claim 1, wherein the fluid storage tank has a capacity of approximately 100 gallons.

4. The apparatus of claim 1, wherein there are a plurality of fluid storage tanks communicatively connected to the control box.

5. The apparatus of claim 1, wherein the controller monitors the supply of fluid in the fluid storage tank and in the vending mechanism.

6. The apparatus of claim 5, wherein the controller monitors supply via a float mechanism disposed in the fluid storage tank or the vending mechanism.

7. The apparatus of claim 5, wherein the controller per nits a predetermined flow of fluid from the fluid storage tank to the fluid flow line upon sensing a low fluid condition in the vending mechanism.

8. The apparatus of claim 7, wherein the controller includes a flow rate sensor.

9. The apparatus of claim 1, wherein the controller includes a pump.

10. The apparatus of claim 1, wherein the controller manages flow via gravity flow.

11. The apparatus of claim 1, wherein the fluid flow line is constructed of polyethylene tubing.

12. The apparatus of claim 1, wherein the vending mechanism comprises a fluid bucket for holding a predetermined volume of fluid and has an access aperture adapted to hold and supply fluid to a squeegee tool.

13. The apparatus of claim 12, wherein the vending mechanism further comprises a paper towel dispenser.

14. The apparatus of claim 1, wherein the vending mechanism comprises a hand holdable fluid vending nozzle adapted to be used on a customer to dispense fluid to a remote container.

15. The apparatus of claim 14, wherein the vending mechanism further comprises a customer access unit for controlling flow of fluid to the vending nozzle.

16. The apparatus of claim 15, wherein the customer access unit comprises a card reader or a cash payment mechanism.

17. An apparatus for bulk windshield washer fluid vending at a service station, comprising:
(a) at least one fluid storage tank for storing windshield washing fluid,
(b) a controller communicatively connected to the at least one fluid storage tank for managing flow of fluid from the fluid storage tank,
(c) at least one fluid flow line connected to the controller, and
(d) a vending mechanism connected to the fluid flow line and disposed at a predetermined location remote from the fluid storage tank and adapted to be actuated by a customer, wherein the vending mechanism comprises a hand holdable fluid vending nozzle adapted to be used on a customer to dispense fluid to a remote container, and a customer access unit for controlling flow of fluid to the vending nozzle, the customer access unit being selected from the group of devices consisting of a card reader and a cash payment mechanism.

8. A method of dispensing fluids, comprising the steps of:
(a) Providing an apparatus for bulk fluid vending, comprising at least one fluid storage tank for storing fluid, a controller communicatively connected to the at least one fluid storage tank for managing flow of fluid from the fluid storage tank, at least one fluid flow line connected to the controller, and a vending mechanism connected to the fluid flow line and disposed at a predetermined location remote from the fluid storage tank and adapted to be actuated by a customer;
(b) detecting a dispense signal at the vending mechanism, and
(c) delivering fluid from the fluid storage tank to the vending mechanism.
